(19) United States
(12) Patent Application Publication
(10) Pub. No.: US 2006/0119241 A1
(43) Pub. Date: Jun. 8, 2006

(54) Automatic gas supplementing device for a discharge luminous tube

(76) Inventor: Jenn-Wei Mii, Taipei City (TW)

Correspondence Address: BRUCE H. TROXELL;SUITE 1404, 5205 LEESBURG PIKE, FALLS CHURCH, VA, 22041, US

(21) Appl. No.: 11/135,389

(22) Filed: May 24, 2005

(30) Foreign Application Priority Data
Dec. 7, 2004 (TW) 93137781
Mar. 15, 2005 (TW) 94107823

(51) Int. Cl. H01J 61/96

(52) U.S. Cl. 313/8

(57) ABSTRACT

An automatic gas supplementing device for a discharge luminous tube includes a hollow tube body with a gas supplementing bottle space being defined in an end thereof. The other end of the tube body connects a chamber body of the luminous tube. A gas resistance component and an electric gas valve device are disposed in the tube body with a gas supplementing volume space being defined therebetween.

### FIELD OF THE INVENTION

The present invention relates to an automatic gas supplementing device for a discharge luminous tube, and particularly to an automatic gas supplementing device which precisely and automatically controls supplementing gas flow and doesnot need to continuously and permanently supplement a small quantity of gas thereby preventing imprecise gas supplementing volume.

### BACKGROUND OF THE INVENTION

A cathode discharge luminous tube is made through vacuumizing a tube body thereof and then filling the tube body with specific gas. Each end of the tube body is disposed with an electrode. The filled gas is under an air pressure between several Tuoers to several hundreds Tuoers. When the electrodes are applied with suitable voltage, the luminous tube lights with desirable light. After a long term of impacting between the gas and the electrodes and sputtering of the electrodes during the gas being processed by the high voltage electrodes, molecules of the gas are absorbed into the electrodes and so the gas in the luminous tube is reduced gradually. When the quantity of the gas in the luminous tube is reduced to some extend, the luminous tube cannot be lighted and so the luminous tube has to be replaced. Or when the gas is reduced, which results in low lighting efficiency and luminosity, the luminous tube is required to be replaced.

Since the luminous tube is made of glass and is disposed with poisonous material therein, it requires to operate very carefully for reducing. environment pollution and maintaining safe operation of cleaners during replacing an old luminous tube, even recycling the old luminous tube. Therefore, the conventional luminous tube has quite a limited life and has to be often replaced, which results in high cost and inconvenient replacing operation. Additionally, the luminous tube is supplemented with gas. However, the gas supplementing operation is complicated and inconvenient. When the gas is supplemented in situ, the remanent gas in the luminous tube is vented through an oven, then the luminous tube is vacuumized through a vacuumizing pump, and then the desirable supplementing gas is filled in the luminous tube through gas supplementing equipment and meter control. The connected electronic and plastic components has to be detached from the luminous tube during roasting the luminous tube for preventing from being destroyed under high temperature, which is inconvenient. If the luminous tube is not roasted, air will enter the luminous tube and so pollute the luminous tube during opening the vacuum tube body, which results the luminous tube cannot be reused. Furthermore, the vacuumizing pump and the gas supplementing equipment are heavy and should be operated by a skilled worker, which is inconvenient. If the luminous tube is sent back to a factory for supplementing gas, the same processes are required and so it is more inconvenient. Since the luminosity of the luminous tube is weakened gradually with the gas being reduced However, the conventional gas supplementing operation should be improved.

U.S. Pat. No. 6,765,345 disclosed an inert gas supplementing device which includes a tube having a closed end and an open end adapted to communicate with a light tube of a fluorescent light, a porous stop received in the tube in an air-tight manner, an inert gas received in an area enclosed by the closed end of the tube and the porous stop. The inert gas is able to seep through the porous stop and flow to the fluorescent light to supplement inert gas in the fluorescent light. Since the porous stop can has the gas supplementing function at any moment, once the fluorescent light is made, it maintains a small quantity of gas to be supplemented permanently. However, when the fluorescent light is not used for a long term, the fluorescent light can not be used due to overfull supplemented gas.

### SUMMARY OF THE INVENTION

Accordingly, an object of the present invention is to provide an automatic gas supplementing device for a discharge luminous tube which can precisely and automatically control supplementing gas flow rate for facilitating to supplement gas to the luminous tube and overcomes the permanent consumption problem caused by the permanently supplementing a small quantity of gas thereby increasing the use life of the luminous tube and keeping luminosity. When gas in the gas supplementing bottle space is used up, the bottle may be refilled with the electric gas valve device being closed, which is ready to do.

To achieve the above object, an automatic gas supplementing device for a discharge luminous tube of the present invention includes a hollow tube body with a gas supplementing bottle space being defined in an end thereof. The other end of the tube body connects a chamber body of the luminous tube. A gas resistance component and an electric gas valve device are disposed in the tube body with a gas supplementing volume space being defined therebetween.

Wherein a hollow tube body with an end connecting a gas supplementing bottle space and the other end connecting a chamber body of the luminous tube, at least two electric gas valve devices being respectively disposed in the tube body with a gas supplementing volume space being defined therebetween.

Wherein each electric gas valve device is disposed in the tube body and includes two opposing stopper bodies disposed in the tube body, a ventilative hole and an elongate hole are respectively defined in the stopper bodies, a gastight member is disposed corresponding to the ventilative hole, an actuating block is disposed at one side of the gastight member, a gap is defined between the actuating block and the tube body, a magnet is disposed in the actuating block, a winding is disposed outside the tube body corresponding to the magnet, a spring is disposed between the actuating block and the stopper body defined with the ventilative hole.

Wherein a sleeve is disposed corresponding to the ventilative hole of the stopper body, a through hole is defined in the sleeve, the gastight member is disposed in the sleeve, a tension spring is disposed between the sleeve and the actuating block, opposite ends of the spring are respectively fixed to the sleeve and the actuating block whereby the gastight member and the ventilative hole keep sealing contact.

Wherein each electric gas valve device is disposed in the tube body and includes two stopper bodies disposed in opposing sides thereof, a ventilative hole and an elongate hole are respectively defined in the stopper bodies, a magnetic actuating member is disposed between the two stopper bodies, the magnetic actuating member includes a guiding block disposed in the electric gas valve device and a magnetic body fixed to the tube body, a gap is defined between the guiding block and the magnetic body, the guiding block has one end disposed with a gastight member corresponding to the ventilative hole of the stopper body and the other end extending through magnetic body, a spring is disposed between the other end of the guiding block and the stopper body having the elongate hole, a gap is defined between a portion of the guiding block projecting the magnetic body and the magnetic body, a winding is disposed outside the tube body corresponding to the magnetic actuating member.

Wherein more than one connecting rod guiding blocks connect in series between the magnetic actuating members of the electric gas valve device disposed between the two stopper bodies in the tube body.

Wherein a sleeve is disposed corresponding to the ventilative hole of the stopper body, a through hole is defined in the sleeve, the gastight member is disposed in the sleeve, a tension spring is disposed between the sleeve and the actuating block, opposite ends of the spring are respectively fixed to the sleeve and the actuating block whereby the gastight member and the ventilative hole keep sealing contact.

Wherein a first pipe is disposed at the stopper body in the tube body, an end of the first pipe gastightly connects a second pipe, a sleeve is disposed outside the second pipe, an end of the guiding block is disposed with a gastight member corresponding to an opening of the second pipe, the guiding block is movable within the sleeve, two clipping rings are respectively defined at the guiding block and the sleeve, a spring is disposed between the two clipping rings whereby the gastight member closes the opening of the second pipe.

Wherein at least two magnetic actuating members controllable the gastight member are connected in series, each magnetic actuating member includes a movable guiding block, a magnetic body disposed in the tube body and a winding disposed outside the tube body, the guiding block of each magnetic actuating member is defined with a receiving space therein, a hole in an axial end thereof and a post in the other end thereof, a through hole is axially defined in the magnetic body, the post of the guiding block extends through the through hole of another magnetic actuating member and into the receiving space and then is formed with a big diameter at the free end thereof, a spring is disposed between the free end of the post and the inner wall of the receiving space.

Wherein a first pipe is disposed through the stopper body in the tube body, an end of the first pipe gastightly connects a second pipe, a sleeve is disposed outside the second pipe, an end of the guiding block is disposed with a gastight member corresponding to an opening of the second pipe and movable within the sleeve, an end of the sleeve is fixed to the post of the gastight member, a clipping ring is defined in the tube body, a spring is disposed between the clipping ring and the free end of the sleeve and outside the sleeve whereby the gastight member closes the opening of the first pipe through pushing the sleeve.

Wherein each electric gas valve device is disposed in the tube body and includes two stopper bodies disposed in opposite sides thereof, a ventilative hole and an elongate hole are respectively defined in the stopper bodies; a gastight member is disposed corresponding to the ventilative hole, an actuating block is disposed at one side of the gastight member, the actuating block is hollow with a spring being defined therein, one end of the spring abuts against the stopper body defined with the elongate hole, the gastight member is disposed within the ventilative hole of the stopper body, a hollow pipe is disposed in a tube body between the two stopper bodies, a control plate is disposed in the hollow pipe, a fulcrum is disposed at the control plate and is pivoted about the hollow pipe, one end of the control plate is fixedly connected to the actuating block, a magnetic body is disposed outside the hollow pipe corresponding to the other end of the control plate, a winding is disposed outside the magnetic body.

Wherein the hollow pipe is L-shaped, a control plate is disposed in the vertical portion of the hollow pipe, one end of the control plate is fixedly connected to the actuating block and the other end of the control plate connects with a rod disposed at the horizontal portion of the hollow pipe, a magnetic body is disposed at one side of the rod, a winding is disposed outside the magnetic body.

Wherein each electric gas valve device is disposed in the tube body and includes two stopper bodies disposed in opposing sides thereof, a ventilative hole and an elongate hole are respectively defined in the stopper bodies; a gastight member is disposed corresponding to the ventilative hole, an actuating block is disposed at one side of the gastight member, an end of the actuating block is hollow and receives a spring therein, the spring has one end disposed at the stopper body defined with the elongate hole, a gastight member is disposed at the other end of the actuating block and is received in the ventilative hole of the stopper body, a hollow pipe is disposed in communication with a chamber body of the luminous tube, a control plates is disposed in the hollow pipe and has an end fixedly connecting the actuating block, a magnetic body is disposed outside the hollow pipe corresponding to the control plates, a winding is disposed outside the magnetic body.

Wherein the electric gas valve device includes a cross-shaped hollow pipe, a winding is disposed outside the hollow pipe, an actuating block is disposed in the hollow pipe, a spring is disposed between the actuating block and the inner wall of the cross-shaped hollow pipe, a gastight member is disposed at the bottom of the actuating block, a stopper body defined with two ventilative holes therein is disposed at the bottom of the gastight member, a sealing film is disposed at the stopper body in a spaced distance, the two ventilative each have one end facing the sealing film and the other end respectively in communication with a gas supplementing volume space and a chamber body of the luminous tube.

Wherein a pushing rod is disposed at an end of the actuating block is defined with an annular groove corresponding to the ventilative hole, a sealing ring is received in the annular groove and at the outer edge of the ventilative hole.

Wherein the tube body is disposed with a T-shaped stopper body therein, a protrusion extends from a middle of the stopper body and projects the tube body, a ventilative hole is defined in the stopper body along an axial direction thereof, a taper hole is defined in the stopper body in communication with the ventilative hole along a diameter direction thereof, an actuating block is disposed corresponding to the protrusion with a taper end, a film is disposed between the actuating block and the stopper body, the film is connected to the inner wall of a receiving opening defined by the protrusion, the taper end matches the taper hole thereby closing or opening the ventilative hole.

Wherein the electric gas valve device includes a hollow pipe, a winding is defined outside the hollow pipe, an actuating block is disposed in the hollow pipe, a spring is disposed between the actuating block and the inner wall of the hollow pipe, a gastight member is disposed at he bottom of the actuating block, a stopper body with a ventilative hole defined therein is disposed at the bottom of the gastight member, a pipe with a side hole defined therein extends from the stopper body, a crapy film canister is fixedly disposed at the stopper body, a bellows is defined between crapy film canister and the stopper body, a slot is defined in the bottom of gastight member for receiving the pipe.

Wherein the electric gas valve device includes a magnetic actuating member designed with an arcuate section, a gastight member is disposed at the bottom of the magnetic actuating member, the magnetic actuating member is corresponding to a magnetic body and a winding both disposed outside the magnetic actuating member, two recesses are defined in the magnetic actuating member and each receive a spring therein, a ventilative hole is defined corresponding to the gastight member, the electric gas valve device is disposed in a tube body, a gas supplementing volume space is defined in the tube body for supplementing gas to a chamber body of the luminous tube.

Wherein a sleeve is defined in the tube body corresponding to each recess of the magnetic actuating member, one end of the sleeve is fixed to the tube body ad the other end is guidable movement of the outer sidewall of the recess.

Wherein opposite ends of the gas supplementing volume space in the hollow tube body are respectively connected with an electric gas supplementing device and a gas resistance component.

An automatic gas supplementing device for a discharge luminous tube comprising two electric gas valve devices respectively disposed in separated box bodies, a ventilative hole being defined between the two box bodies, two magnetic bodies and two windings controlling the two electric gas valve devices, each electric gas valve device being disposed with a plurality of hollow posts in the box body corresponding to the magnetic bodies and magnetic actuating members corresponding to the magnetic bodies, a recess being defined in the center of the magnetic actuating member, a spring being received in the recess, a gastight member being disposed under the magnetic actuating member corresponding to a ventilative hole, a plurality of post bodies being disposed under the magnetic actuating member corresponding to the hollow post, the opposite ends of the two box bodies respectively connecting a gas supplementing bottle space and a chamber body of the luminous tube.

Wherein the electric gas valve device and the chamber body of the luminous tube are separate with a conduit being connected therebetween.

Wherein opposite ends of the gas supplementing volume space in the hollow tube body are respectively connected with the electric gas supplementing device and a gas resistance component.

Wherein positions of the gas resistance component and the electric gas valve device are interchangeable.

Wherein a heater is disposed outside the tube body corresponding to the gas supplementing volume space and the gas supplementing end.

Wherein a sensor is disposed in the chamber body of the luminous tube.

Wherein a filter is disposed between the stopper body and the chamber body of the luminous tube for filtering impurity of the gas.

Wherein the gas resistance is replaced with a hollow pipe with a small diameter or a ventilative body, one end of the hollow pipe directly connects the ventilative hole of the gastight member.

Other objects, advantages and novel features of the present invention will be drawn from the following detailed embodiment of the present invention with attached drawings, in which:

### BRIEF DESCRIPTION OF THE DRAWINGS

FIG. 1A is a perspective view of an automatic gas supplementing device in accordance with a first embodiment of the present invention;

FIG. 1B is a partially perspective view in accordance with the first embodiment of the present invention;

FIG. 2 is a cross-sectional view of part of FIG. 1 showing an assembly of a gas resistance component and an electric gas valve device;

FIG. 2A is similar to FIG. 2 but showing an alternative embodiment;

FIG. 2B is similar to FIG. 2 but showing another alternative embodiment;

FIG. 2-1 to FIG. 2-5 are cross-sectional views showing various embodiments of the gas resistance component;

FIG. 3 is a cross-sectional view of an automatic gas supplementing device in accordance with a second embodiment of the present invention;

FIG. 3A is a cross-sectional view showing an alternative embodiment of the stopper body and the gastight member shown in FIGS. 1-2;

FIG. 4A is a cross-sectional view of an automatic gas supplementing device in accordance with a third embodiment of the present invention viewed from a left side;

FIG. 4B is similar to FIG. 4A but viewed from a right side;

FIG. 5 is a cross-sectional view of an automatic gas supplementing device in accordance with a fourth embodiment of the present invention;

FIG. 5A is a cross-sectional view showing an alternative embodiment of the stopper body and the gastight member shown in FIGS. 4-5;

FIGS. 5B and 5D are similar to FIG. 5A showing alternative embodiments;

FIGS. 5C-1 and 5C-2 are cross-sectional views showing alternative embodiments of a magnetic actuating member shown in FIG. 5B;

FIG. 6 is a cross-sectional view showing a lever type electric gas valve device;

FIG. 7 is a cross-sectional view showing a steeve type electric gas valve device;

FIG. 8 is a cross-sectional view showing a crossband type electric gas valve device;

FIG. 9 is a cross-sectional view showing a plane type electric gas valve device;

FIG. 9A is similar to FIG. 9 but showing an alternative embodiment;

FIG. 10 is an exploded view showing a plane type electric gas valve device;

FIG. 11 is a cross-sectional view showing a semicolumn type electric gas valve device;

FIG. 11A is a cross-sectional view of FIG. 11;

FIG. 12 is an exploded view showing the semicolumn type electric gas valve device;

FIG. 13 is a cross-sectional view showing a film type electric gas valve device, an alternative embodiment of a gastight member;

FIG. 14 is a cross-sectional view showing a bellows type electric gas valve device;

FIG. 15 is a cross-sectional view showing an alternative embodiment of a gastight member of FIG. 14; and

FIG. 16 is a cross-sectional view showing a heater being combined to FIG. 3.

### DESCRIPTION OF THE PREFERRED EMBODIMENTS

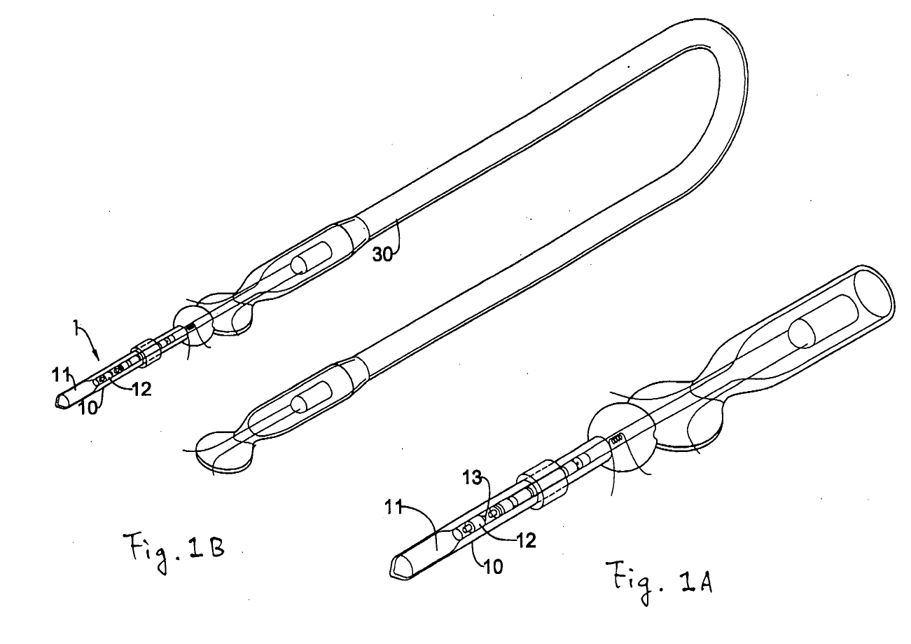

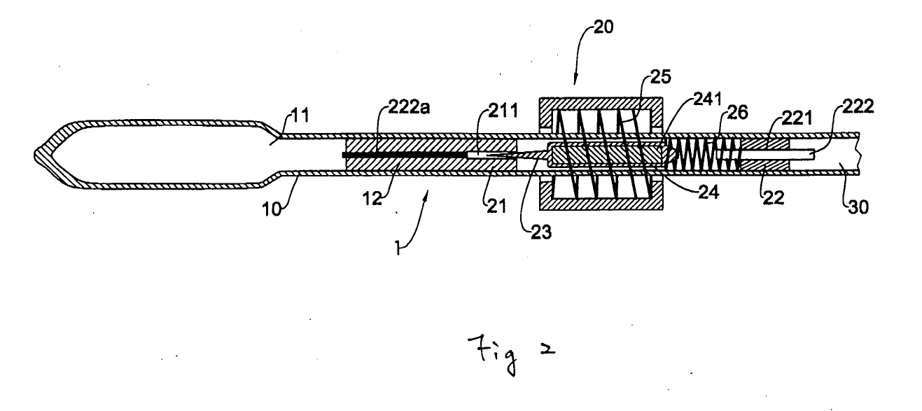

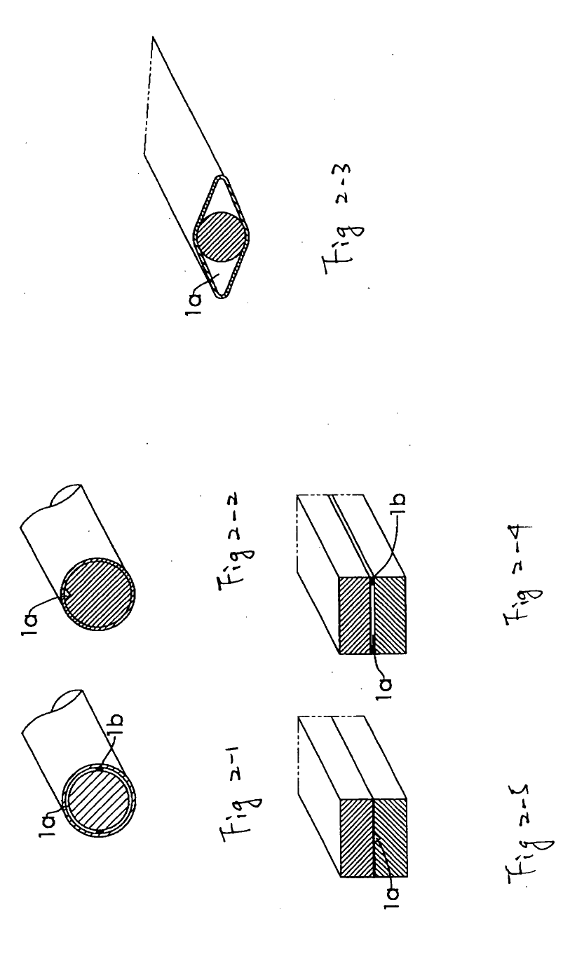

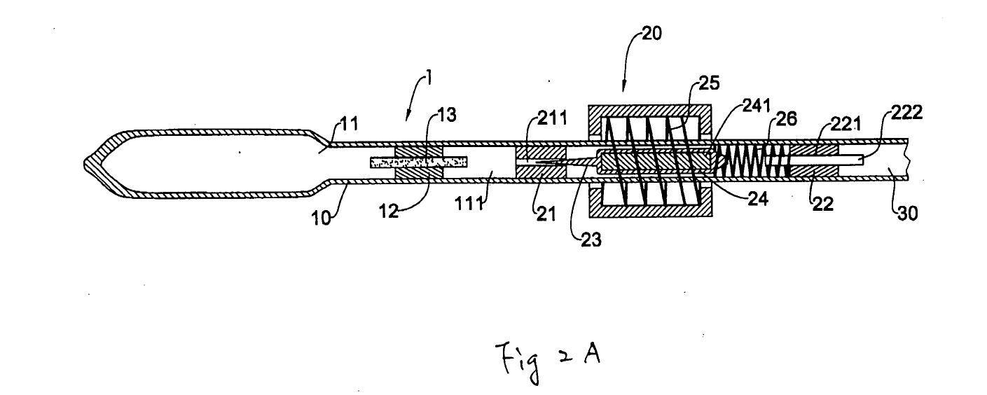

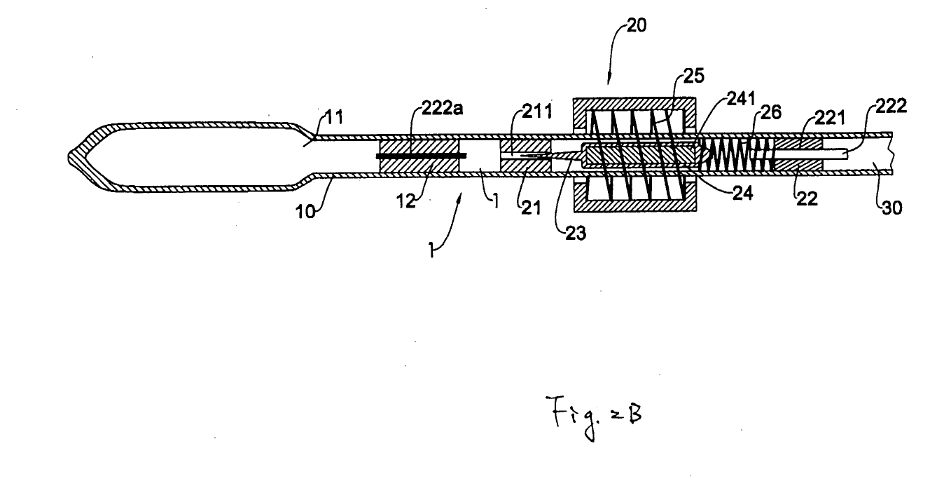

Referring to FIGS. 1A, 1B and 2, an automatic gas supplementing device for a discharge luminous tube in accordance with a first embodiment of the present invention is shown. The automatic gas supplementing device includes a hollow tube body 10 with a hollow gas supplementing bottle space 11 being defined therein. A gas resistance component 1 is disposed in the tube body 10 at an end of the gas supplementing bottle space 11. The gas resistance component 1 is fixed by a stopper 12. A gas supplementing volume space 111 is defined in the other end of the gas supplementing bottle space 11 opposing to the gas resistance component 1. The gas resistance component 1 may be a hollow small tube 222a or a ventilative member 13 (see FIGS. 2, 2A and 2B).

The present invention is characterized in controlling gas supplementing operation through an electric gas valve device 20 and the gas resistance component 1. The electric gas valve device 20 is disposed in the tube body 10. The gas resistance component 1 is adjacent to the gas supplementing bottle space 11 at one end thereof and adjacent to the electric gas valve device 20 at the other end thereof.

The electric gas valve device 20 further includes two opposing stopper bodies 21, 22 disposed in the tube body 10. A ventilative hole 211 and an elongate hole 221 are respectively defined in the stopper bodies 21, 22. A hollow pipe 222 is received in the elongate hole 221.

A gastight member 23 is disposed corresponding to the ventilative hole 211. An actuating block 24 is disposed at one side of the gastight member 23. A gap is defined between the actuating block 24 and the tube body 10. A magnet 241 is disposed in the actuating block 24. A winding 25 is disposed outside the tube body 10 corresponding to the magnet 241. A spring 26 is disposed between the actuating block 24 and the stopper body 22.

In use of the automatic gas supplementing device of the present invention, the gas supplementing bottle space 11 at one end of the tube body 10 is vacuumized, then is filled with given gas and then is sealed. The other end of the tube body 10 is for connecting a chamber body 30 of the luminous tube. When the gastight member 23 is pushed by the spring 26 to close the ventilative hole 211, the automatic gas supplementing device is at a non-supplementing status. When electrified, the winding 25 interacts with the magnet 241 thereby moving the actuating block 24 toward the spring 26. Therefore, a gap occurs between the gastight member 23 and the ventilative hole 211 and so the given gas desired for supplementing flows through the gas resistance component 1, the gas supplementing volume space 111, the gap between the ventilative hole 211 and the gastight member 23, the gap between the actuating block 24 and the tube body 10, and the hollow pipe 222 and then into the chamber body 30 of the luminous tube.

Since the electric gas valve device 20 can be controlled to work in a proper interval, the chamber body 30 of the luminous tube has a function of supplementing gas in batches and in the interval but not permanently supplementing a small quantity of gas.

The gas resistance component 1 is used to reduce the gas flow rate during supplementing gas. When the electric gas valve device 20 is turned off, the high pressure gas in the gas supplementing bottle space 11 is slowly supplemented to the gas supplementing volume space 111 through the gas resistance component 1 after a period of time. When the electric gas valve device 20 is turned on, the gas of the gas supplementing volume space 111 instantaneously flows to the chamber body 30 of the luminous tube. Though the electric gas valve device 20 is momently turned on, since the gas flow rate of the gas resistance component 1 is very slow, all of the gas in the gas supplementing bottle space 11 doesnot flow instantaneously into the chamber body 30 of the luminous tube. The installation positions of the gas resistance component 1 and the electric gas valve device 20 of the tube body may be interchanged.

Referring to FIG. 2, as an embodiment, the gas resistance component 1 is a hollow small pipe 222a disposed in the stopper 12 with a small inner diameter. Or the gas resistance component 1 is a ventilative body 13 disposed at the stopper 12 as shown in FIG. 2A. The gas resistance components 1 in both embodiments can have same ventilative effect in a small quantity. Referring to FIG. 2, the hollow small pipe 222a of the gas resistance component 1 is directly connected with the ventilative hole 211. The gas supplementing volume space 111 is defined between the hollow small pipe 222a and the electric gas valve device 20 (see FIG. 2B) or between the ventilative body 13 and the electric gas valve device 20 (see FIG. 2A).

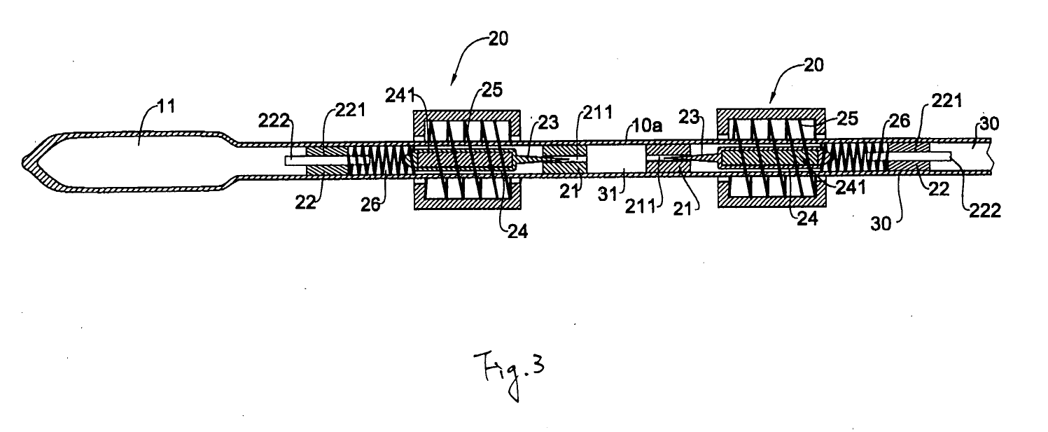

Referring to FIGS. 2-1 to 2-5, various embodiments of the gas resistance component 1 disposed at the tube body 10 or the stopper 12 are shown. A plurality of spacers 1b is disposed between a column and the hollow pipe thereby defining through holes 1a between the hollow pine and the column (see FIG. 2-1). The column is closed to the hollow pipe with a plurality of grooves being defined in the outer surface thereof thereby defining through holes 1a between the hollow pipe and the column (see FIG. 2-2). A column is disposed in a non-circular pipe thereby defining through holes 1a between the column and the pipe (see FIG. 2-3). A plurality of spacers 1b is defined between two rectangular bodies thereby defining a through hole 1a therebetween (see FIG. 2-4). Two rectangular bodies are closely connected with a groove being defined in a connecting surface of one of rectangular bodies thereby defining a through hole 1a (see FIG. 2-5). All of the above through holes 1a are with a small cross-sectional size for providing a desirable small quantity of gas flow.

Referring to FIG. 3, an automatic gas supplementing device in accordance with a second embodiment of the present invention includes a hollow tube body 10a. An electric gas valve device 20 is disposed in each side of the tube body 10a or at least two electric gas valve devices 20 are disposed in the tube body 10a. Each electric gas valve device 20 includes two opposing stopper bodies 21, 22 disposed in the tube body 10a. A ventilative hole 211 and an elongate hole 221 are respectively defined in the stopper bodies 21, 22. A hollow pipe 222 is received in the elongate hole 221. A gastight member 23 is disposed corresponding to the ventilative hole 211. An actuating block 24 is disposed at one side of the gastight member 23. A gap is defined between the actuating block 24 and the tube body 10a. A magnet 241 is disposed in the actuating block 24. A winding 25 is disposed outside the tube body 10a corresponding to the magnet 241. A spring 26 is disposed between the actuating block 24 and the stopper body 22.

The electric gas valve devices 20 are respectively disposed in right and left sides of the tube body 10a with two hollow pipes 222 being far away from each other. The stopper bodies 21 with the ventilative holes 211 are disposed in the tube body 10a and are close to each other. The electric gas valve devices 20 are respectively disposed outside the stopper bodies 21. One side of the tube body 10a is vacuumized, then is filled with given gas at an atmospheric pressure or at a high pressure and then is sealed thereby defining a gas supplementing bottle space 11. The other side of the tube body 10a is for connecting a chamber body 30 of the luminous tube. A gas supplementing volume space 31 is defined between the two electric gas valve devices 20 of the tube body 10a. A pressure sensor (not shown) may be respectively disposed at the gas supplementing volume space 31 and the chamber body 30 of the luminous tube.

When the sensor detects that the gas in the chamber body 30 of the luminous tube is not enough, the electric gas valve device 20 close the chamber body 30 of the luminous tube is actuated to supplement the gas in the gas supplementing volume space 31 through the ventilative hole 211 to chamber body 30 of the luminous tube. When the gas of the chamber body 30 is supplemented to be enough, the sensor directs the gas valve to stop. When the gas in the gas supplementing volume space 31 is not enough, the sensor directs the electric gas valve device 20 close the gas supplementing bottle space 31 to supplement the gas through the ventilative hole 211 to the gas supplementing volume space 31.

The automatic gas supplementing device of the present invention achieves to instantaneously supplement gas in batches. The gas supplementing volume space 31 is filled with inert gas. One side of the tube body 10a is connected with the gas supplementing bottle space 11. When the electric gas valve device 20 close the chamber body 30 of the luminous tube actuates the actuating block 24 and the gastight member 23 to move, a gap occurs between the ventilative hole 211 and the gastight member 23 and so the inert gas or given gas can be instantaneously supplemented to the luminous tube in batches but not permanently supplemented to the luminous tube in a small quantity. When the inert gas in the gas supplementing volume space 31 is not enough, the sensor directs the electric gas valve device 20 close the gas supplementing bottle space 11 to work, the given (inert) gas flows into the gas supplementing volume space 31 for next gas supplementing.

Referring to FIG. 3A, an alternative embodiment of the stopper body 21 and the gastight member 23 is shown. A hollow sleeve 261 is disposed at one end of stopper body 21 and in communication with the ventilative hole 211. A plurality of through holes 262 is defined in the sleeve 261. The gastight member 23 extends into the sleeve 261. A tension spring 26 is disposed between the stopper body 21 and the actuating block 24 whereby the flange of the gastight member 23 and the edge of the ventilative hole 211 often keep sealing contact.

Through the above structure, the gastight member 23 is guided to move by the sleeve 261 thereby reducing deformation of the movement thereof. The given gas is ready to flow through the ventilative hole 262. It doesnot need the stopper body 22 for the movement of the spring 26, which facilitates to reduce the inner space of the tube body.

In addition, the positions of the gastight member 23 and the stopper body 21 relative to the gas supplementing bottle space 11, the chamber body 30 of the luminous tube or the gas supplementing volume space 111 may be varied in accordance with different demands.

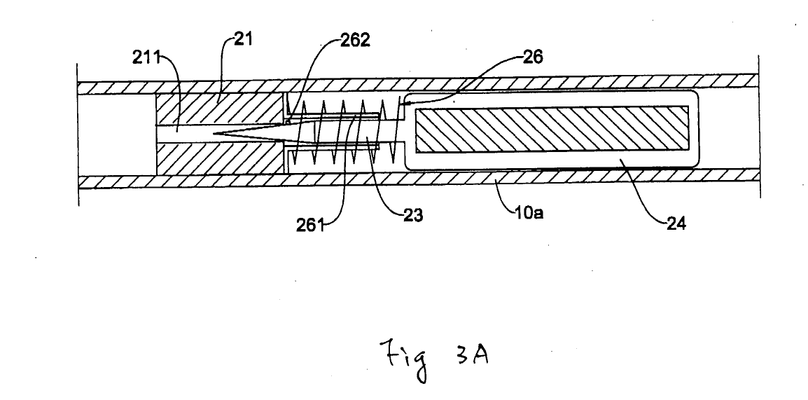

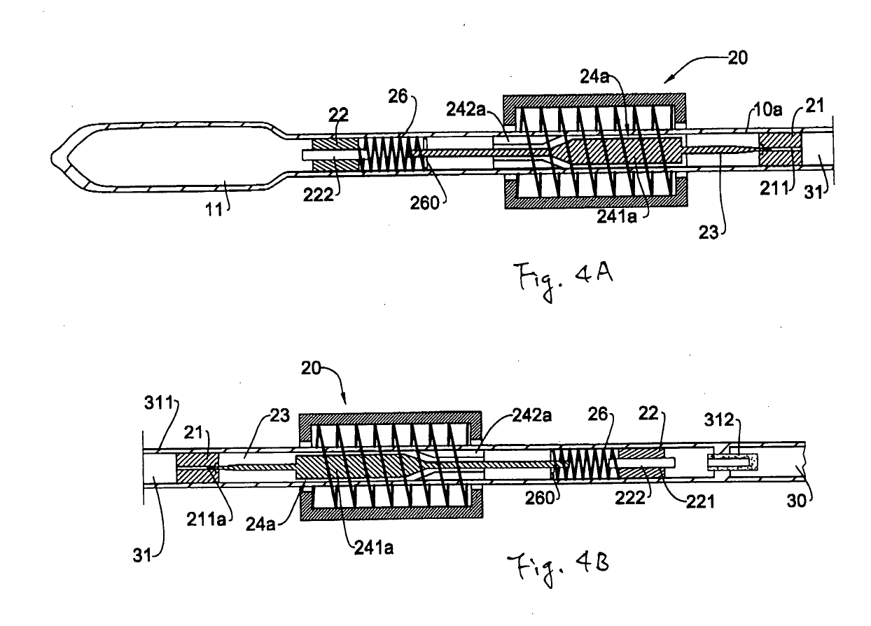

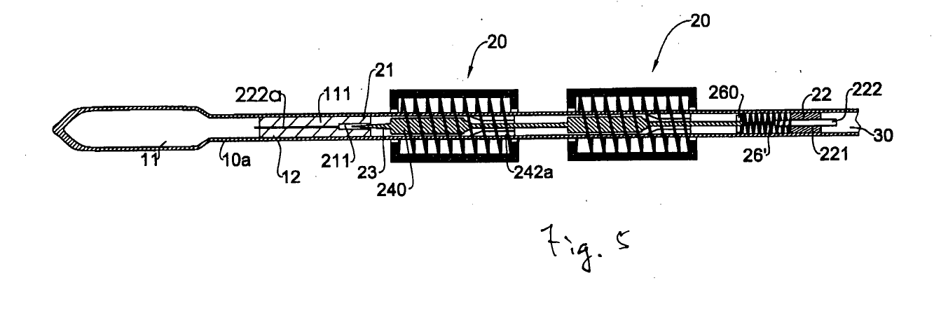

Referring to FIGS. 4A and 4B, an automatic gas supplementing device in accordance with a third embodiment of the present invention is shown. A (linear) electric gas valve device is adopted in this embodiment. Most of the structure of the third embodiment is similar to the second embodiment as shown in FIG. 3. The difference is that a magnetic actuating member 24a is disposed between the stopper body 21 and the stopper body 22. The magnetic actuating member 24a includes a guiding block 241 a disposed in the electric gas valve device 20 close the stopper body 21 and a magnetic body 242a close the stopper body 22. A proper distance is defined between the guiding block 241 a and a magnetic body 242a. The magnetic body 242a is disposed in the tube body 10a. The guiding block 241 a has one end disposed with a gastight member 23 in the edge of the ventilative hole 211 of the stopper body 21 and the other end extending through magnetic body 242a and then disposed with a clipping ring 260. A spring 26 is disposed between the clipping ring 260 and the stopper body 22. A gap is defined between the clipping ring 260 and the tube body 10a for gas communication. A winding is disposed outside the tube body 10a corresponding to the magnetic actuating member 24a.

When the magnetic actuating member 24a generates magnetism through the magnetic field of the winding, magnetic body 242a and guiding block 241a attract together thereby moving the guiding block 241a toward the stopper body 22. Therefore, the spring 26 is compressed and the gas for supplementing flows through the hollow pipe 222, the gap between the guiding block 241a and the magnetic body 242a, the gap between the guiding block 241a and the tube body 311, and the gap between the ventilative hole 211 of the other stopper body 21 and the gastight member 23, and then into the gas supplementing volume space 31 and then enters chamber body 30 of the luminous tube under the control of another electric gas valve device 20. A tiny hole filter 312 is disposed between the stopper body 22 and the chamber body 30 of the luminous tube for filtering impurity of the gas thereby increasing the life of the luminous tube. In addition, the filter 312 may be replaced with the above-mentioned ventilative body.

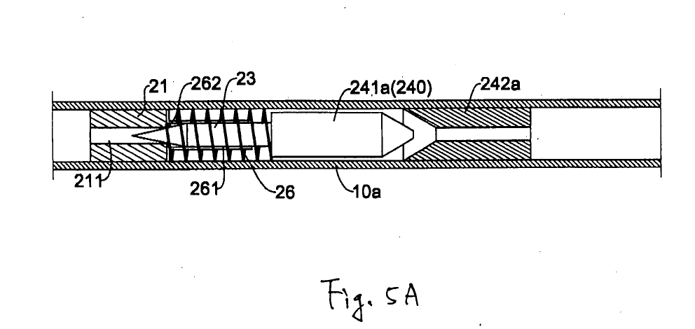

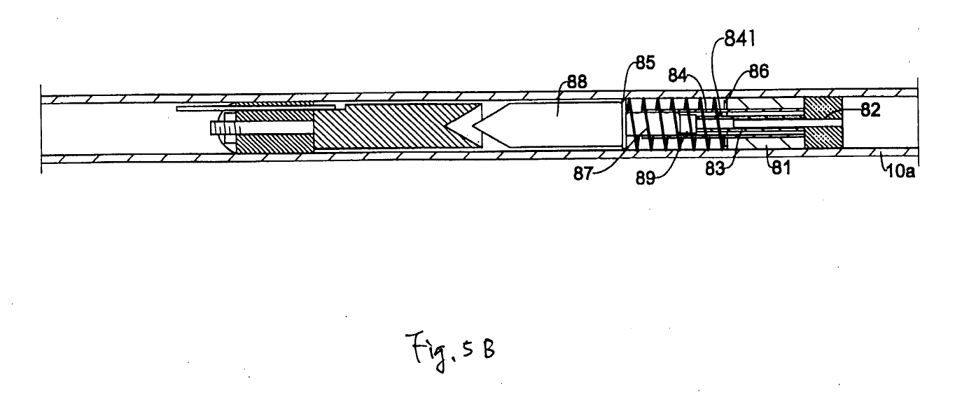

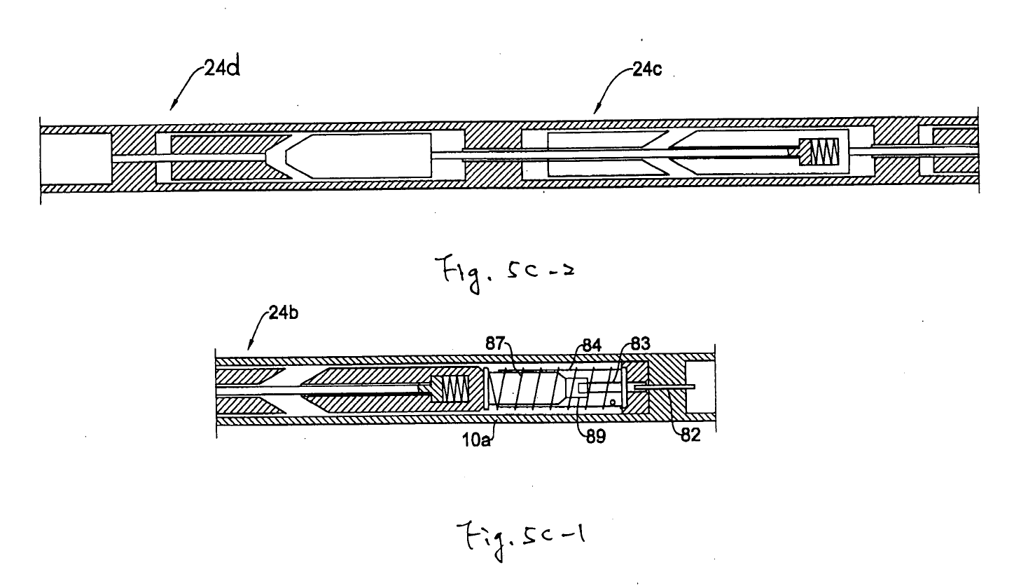

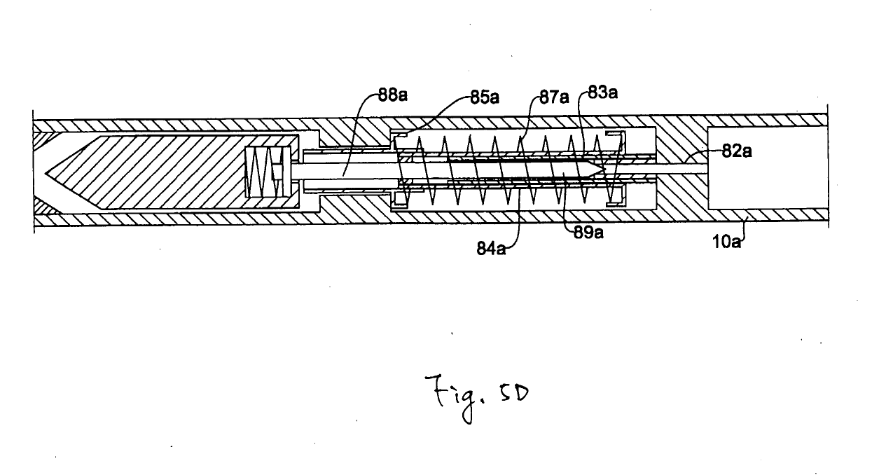

Referring to FIG. 5, a series strengthening electric gas valve device is shown. In an embodiment, the series strengthening electric gas valve device may cooperate with a hollow small pipe 222a or another series strengthening electric gas valve device. Most of structure of the electric gas valve device shown in FIG. 5 is similar to that shown in FIG. 4. The difference is that more than one magnetic actuating member 24a shown in FIG. 4 is added in series. An end of the hollow tube body 10a is vacuumized, then is filled with inert gas at an atmospheric pressure (or high pressure), and then is sealed thereby defining gas supplementing bottle space 11. A hollow small pipe 222a disposed in the stopper 12 is disposed in the tube body 10a. The gas supplementing bottle space 11 is connected with one electric gas valve device 20 corresponding to one end of the hollow pipe 222a.

The other series electric gas valve device 20 is connected with the chamber body 30 of the luminous tube. The above-mentioned two electric gas valve devices include two opposing stopper bodies 21, 22 disposed in the tube body 10a. A ventilative hole 211 and an elongate hole 221 is respectively disposed in the stopper bodies 21, 22. A hollow pipe 222 is disposed in the elongate hole 221. A gastight member 23 is disposed corresponding to one end of the ventilative hole 211. The other end of the ventilative hole 211 is connected with the hollow pipe 222a. A connecting rod guiding block 240 is disposed at one end of the gastight member 23. A magnetic body 242a fixed at the tube body 10a is disposed at the connecting rod guiding block 240. A proper distance is defined between the connecting rod guiding block 240 and the magnetic body 242a. A gap is defined between the connecting rod guiding block 240 and the tube body 10a for gas passing. A gap is defined between a portion of the connecting rod guiding block 240 extending through the magnetic body 242a and the magnetic body 242a. A winding is disposed outside the magnetic body 242a. A clipping ring 260 is disposed at one end of the connecting rod guiding block 240. A spring 26′ is disposed between the clipping ring 260 and the stopper body 22.

In an ordinary status, the spring 26′ pushes the gastight member 23 of the connecting rod guiding block 24 to abut against the edge of the ventilative hole 211, which is at a sealing and non-supplementing gas status. When a sensor detects that the gas in the chamber body 30 of the luminous tube is insufficient, the sensor directs the electric gas valve device 20 to operate. The magnetic body 242a generates magnetism to move the connecting rod guiding block 240 for compressing the spring 26′ whereby a gap occurs between the gastight member 23 and the ventilative hole 211. Thus, the gas instantaneously flows into the chamber body 30 of the luminous tube thereby achieving precise and automatic gas supplementing. The linear dual magnetic actuating members double magnetic area whereby the magnetic force is large. Thus, the pressure of the spring is increased thereby increasing the sealing effect. Compared with the above single winding, each of the two windings is smaller in circle thereby facilitating to reducing the volume of the luminous tube.

Referring to FIG. 5A, an alternative embodiment of the stopper body 21 and the gastight member 23 shown in FIGS. 4-5 is shown. A hollow sleeve 261 is disposed at one end of stopper body 21 and in communication with the ventilative hole 211. A plurality of through holes 262 is defined in the sleeve 261. The gastight member 23 extends into the sleeve 261. A tension spring 26 is disposed between the stopper body 21 and the connecting rod guiding block 240 or guiding block 241a whereby the flange of the gastight member 23 and the edge of the ventilative hole 211 often keep sealing contact.

Referring to FIG. 5B, a stopper body 81 and a magnetic body are spacedly disposed in the tube body 10a. A guiding block 88 is disposed between the stopper body 81 and the magnetic body. A gastight member 89 is disposed at an end of the guiding block 88. First and second pipes 82, 83 are disposed in the stopper body 81. The second pipe 83 receives part of the first pipe 82. A sleeve 84 is disposed outside the second pipe 83 with a plurality of through hole 841 defined therein. The portion of the guiding block 88 disposed with the gastight member 89 is movable within the sleeve 84. The gastight member 89 is opposite to the second pipe 83. A clipping ring 85 is defined at the guiding block 88. Another clipping ring 86 is disposed at the stopper body 81 corresponding to the clipping ring 85. A spring 87 is disposed between the two clipping rings 85, 86 whereby the gastight member 89 closes an opening end of the second pipe 83 through the elasticity of the spring 87.

Through the above structure, the gastight member is guided to move by the sleeve 261, 84 thereby reducing deformation of the movement thereof. The given gas is ready to flow through the through hole 262, 841. It doesnot need the stopper body 22 for the movement of the spring 26, which facilitates to reduce the inner space of the tube body.

Referring to FIGS. 5C-1 and 5C-2, alternative embodiments of a magnetic actuating member shown in FIG. 5B are shown. First, second and third magnetic actuating members 24b, 24c, 24d are connected in series. Each magnetic actuating member 24b, 24c, 24d is same as shown in FIG. 5 and includes a movable guiding block, a magnetic body disposed in the tube body 10a and a winding (not shown) disposed outside the tube body 10a. The guiding block of each magnetic actuating member is defined with a receiving space therein, a hole in an axial end thereof and a post in the other axial end thereof. A through hole is axially defined in the magnetic body.

The first and second magnetic actuating members are described as an example for illustrating the connection manner thereof. The guiding block of the first magnetic actuating member 24b is defined with a through hole at one end thereof and a gastight member 89 at the post of the other end. The post of the guiding block of the second magnetic actuating member extends through the through hole of the first magnetic actuating member and into the receiving space and then is formed with a big diameter at the free end thereof. A spring is received in the receiving space and abuts against the free end. The connection manner of the second and third magnetic actuating members 24c, 24d is same as the above.

The gastight member 89 and the second pipe 83 may be respectively made of copper and steel. The copper gastight member 89 contacts the steel pipe 83 under the control of the first magnetic actuating member 24b. After a period of use, the copper gastight member 89 is shortened due to abrasion between the copper gastight member 89 and the steel second pipe 83. The gap between the guiding block and the magnetic body is enlarged, which results the movement of the guiding block is out of control. To overcome the above problem, the second magnetic actuating member 24c is employed to control the guiding block and the magnetic body. When the gap is increased so big that the second magnetic actuating member 24c fails in control (see FIG. 5C), the third magnetic actuating member 24d is employed to control. The magnetic actuating members may be connected in series in different numbers in the above manner in accordance with different embodiments or designs.

Referring to FIG. 5D, an alternative embodiment of the gastight member shown in FIG. 5A is shown. A first pipe 82a is disposed at the stopper body of tube body 10a. A second pipe 83a is connected with an end of the first pipe for guidance. A cone-shaped gastight member 89a is formed at an end of a guiding block 88a corresponding to the end of the first pipe 82a. A sleeve 84a is disposed outside the guiding block 88a. The second pipe 83a is disposed between the guiding block 88a and the sleeve 84a. A clipping ring 85a is defined at the stopper body of the tube body 10a. A spring 87a is disposed between the the clipping ring 85a and a free end of the sleeve 84a. The spring 87a often pushes the sleeve 84a wthereby the gastight member 89a closes the first pipe 82a.

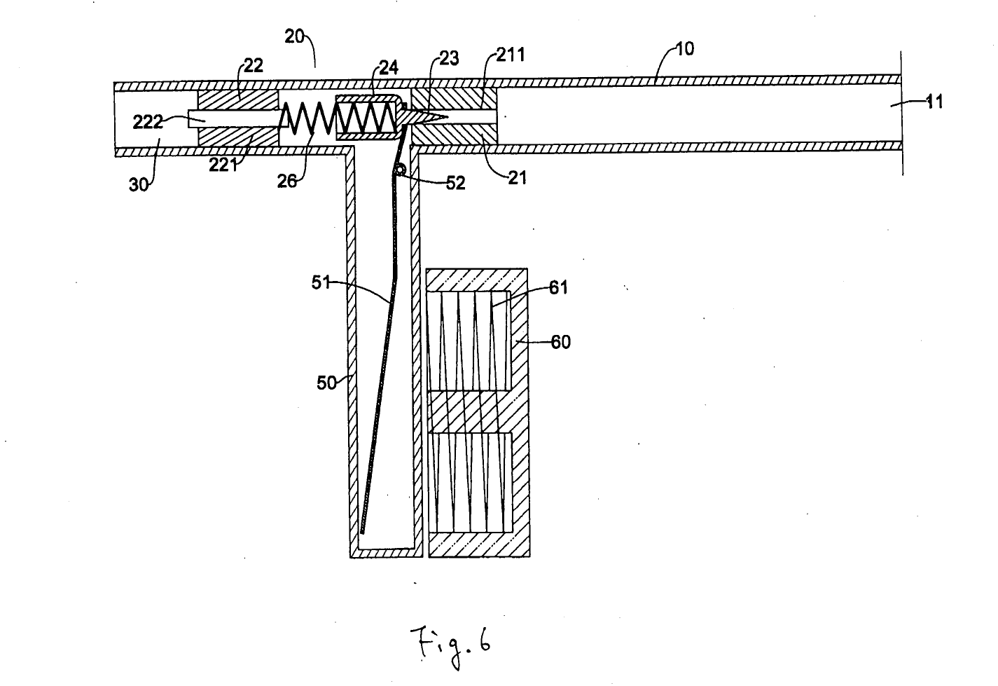

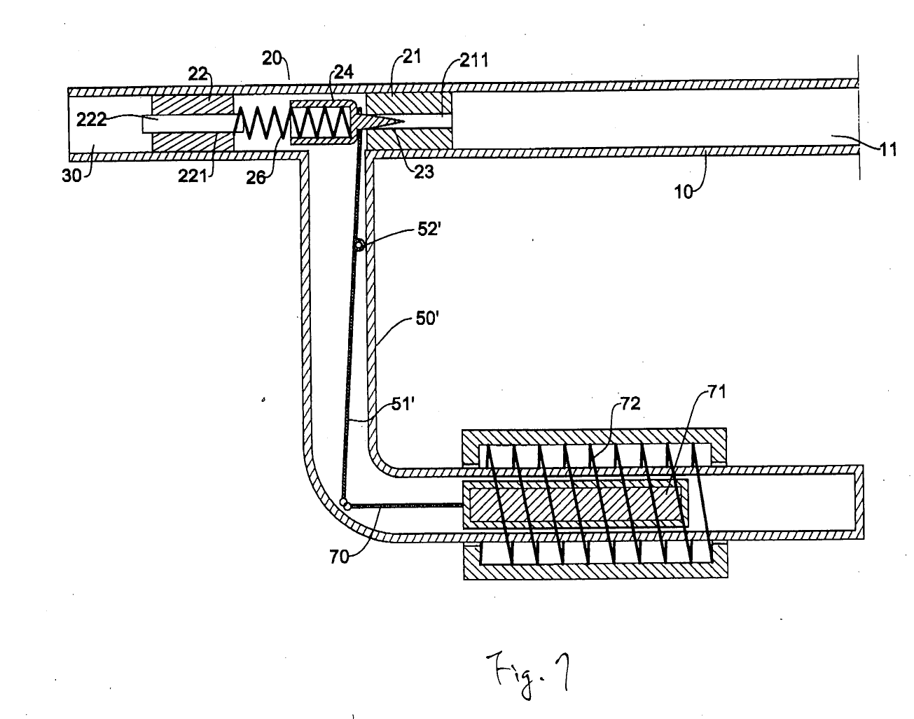

Referring to FIG. 6, a lever type electric gas valve device is shown with proper control function. A stopper body 21 with a ventilative hole 211 being defined therein and a stopper body 22 with a hollow pipe 222 being disposed therein are disposed in a tube body 10. An electric gas valve device 20 and a hollow pipe 50 are respectively disposed between the stopper bodies 21, 22. Compared with the electric gas valve device shown in FIG. 2, the actuating block 24 is differently configured. The actuating block 24 is hollow with a spring 26 being defined therein. A gastight member 23 contactable to the edge of the ventilative hole 211 is disposed at an end of the actuating block 24 opposing the spring 26. One end of the spring 26 abuts against the stopper body 22 thereby pushing the gastight member 23 to close the ventilative hole 211.

A control plate 51 is disposed in the hollow pipe 50. A fulcrum 52 is disposed at the control plate 51 and is pivoted about the hollow pipe 50. One end of the control plate 51 is fixedly connected to the actuating block 24. A magnetic body 60 is disposed outside the hollow pipe 50 corresponding to the other end of the control plate 51. A winding 61 is disposed outside the magnetic body 60 for attracting or releasing the control plate 51. When the control plate 51 pushes the actuating block 24, a gap occurs between the gastight member 23 and the ventilative hole 211 whereby the precise automatic gas supplementing to a chamber body 30 of a luminous tube is achieved. The lever type electric gas valve device can obtain a relatively large force through adjusting the position of the fulcrum 52 for facilitating to increase the gastight effect.

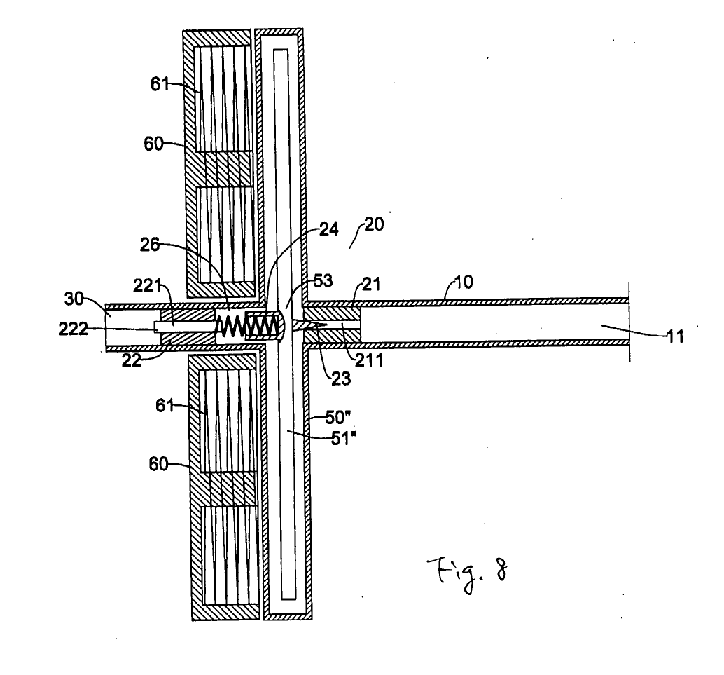

Referring to FIG. 7, a steeve type electric gas valve device is shown. Most of the structure of the steeve type electric gas valve device is similar that shown in FIG. 6. The difference is that a hollow pipe 50′ is L-shaped. A control plate 51′ and a fulcrum 52′ are disposed in the hollow pipe 50′. One end of the control plate 51′ is fixedly connected to the actuating block 24 and the other end of the control plate 51′ connects with a rod 70. A magnetic body 71 is disposed at one side of the rod 70. A winding 72 is disposed outside the magnetic body 71. When the magnetic body 71 attracts or pushes the control plate 51′, the control plate 51′ moves the actuating block 24 to define a gas between the gastight member 23 and the ventilative hole 211 thereby achieving to precisely and automatically supplement gas to the chamber body 30 of the luminous tube.

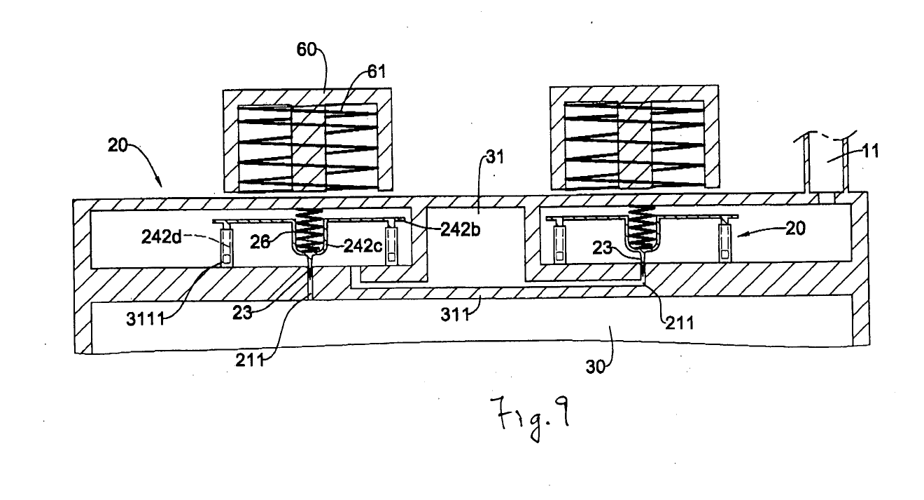

Referring to FIG. 8, a crossband type electric gas valve device is shown. Stopper bodies 21, 22 are disposed in the tube body 10. A hollow pipe 50″ and a hollow actuating block 24 are disposed between the stopper bodies 21, 22. A spring 26 is disposed between the actuating block 24 and the stopper body 22. A gastight member 23 is disposed at an end of the actuating block 24 corresponding to the stopper body 21. A hollow pipe 222 is disposed at the stopper body 22 and is in communication with the chamber body 30 of the luminous tube. Two control plates 51″ each with an arcuate section are disposed in the hollow pipe 50″. A connection plate 53 is disposed at each control plate 51″ and fixedly connects the actuating block 24. Two magnetic bodies 60 are respectively disposed outside the hollow pipe 50″ corresponding to the control plates 51″. Two windings 61 are respectively disposed outside the magnetic bodies 60. When the magnetic bodies 60 attract or release the control plates 51″, the control plates 51″ push the actuating block 24 to define a gas between the gastight member 23 and the ventilative hole 211 thereby achieving to precisely and automatically supplement gas to the chamber body 30 of the luminous tube. The crossband type electric gas valve device can obtain a large force to press the spring due to a big magnetic attractive area thereby facilitating to enhance the gastight effect.

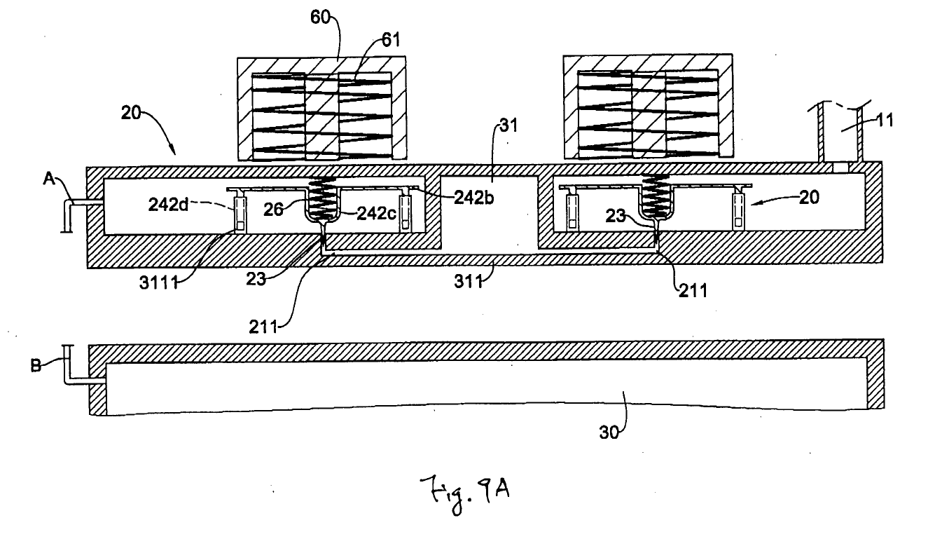

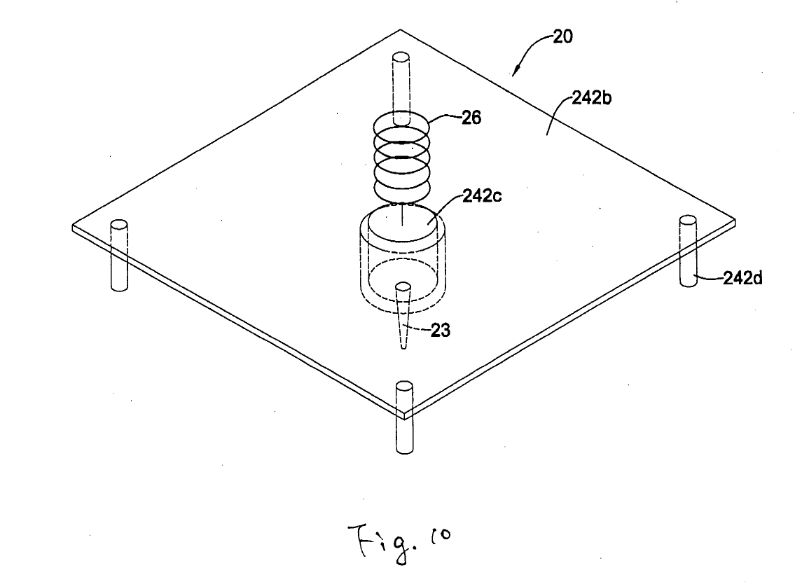

Referring to FIGS. 9 and 10, a plane type electric gas valve device is shown. In this embodiment, two magnetic bodies 60 and two windings 61 control two electric gas valve devices 20. Each electric gas valve device 20 is disposed with a plurality of hollow posts 3111 in the box body 311 corresponding to the magnetic bodies 60 and magnetic actuating member 242b corresponding to the magnetic bodies 60. A recess 242c is defined in the center of the magnetic actuating member 242b. A spring 26 is received in the recess 242c and is disposed between the magnetic actuating member 242b and an inner wall of the box body 311. A gastight member 23 is disposed under the magnetic actuating member 242b corresponding a ventilative hole 211. A plurality of post body 242d is disposed under the magnetic actuating member 242b corresponding to the hollow post 3111 as guidance of the hollow post 3111 for facilitating the to-and-fro movement of the magnetic actuating member 242b.

A gas supplementing bottle space 11 is defined in one end of the box body 311. The chamber body 30 of the luminous tube is disposed at the other end of the box body 311. Through controlling the gastight member 23 to be open or close relative to the ventilative hole 211, the gastight member 23 can realize to precisely and automatically supplement gas to the chamber body 30 of the luminous tube. The gastight member 23 may be cone-shaped or shaped as an annular gasket. The plane type electric gas valve device is applicable that the luminous vacuum chamber is a rectangular box body.

Referring to FIG. 9A, an alternative embodiment of the electric gas valve device shown in FIG. 9 is shown. The box body 311 connected to the gas supplementing bottle space 11 and the chamber body 30 of the luminous tube are separated. A conduit A is disposed in the box body 311 far away from the gas supplementing bottle space 11. A conduit B is disposed at the chamber body 30 of the luminous tube. Therefore, the box body 311 of the electric gas valve device can connect with the chamber body 30 of the luminous tube in accordance with different demands thereby increasing flexibility thereof.

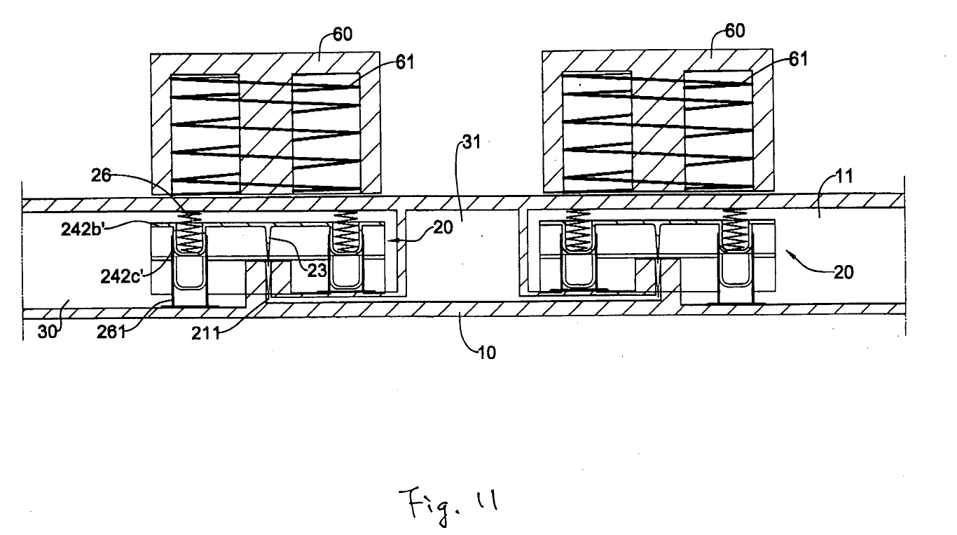

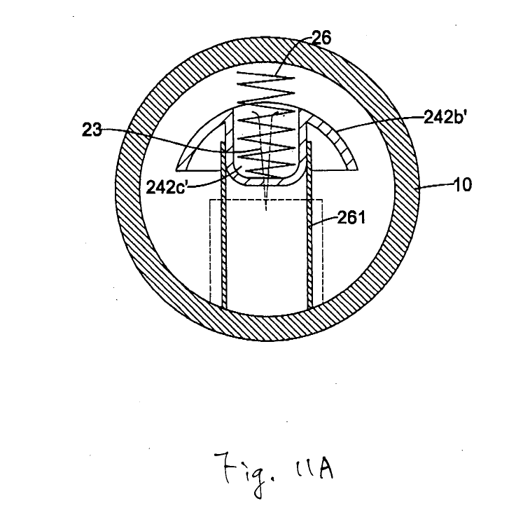

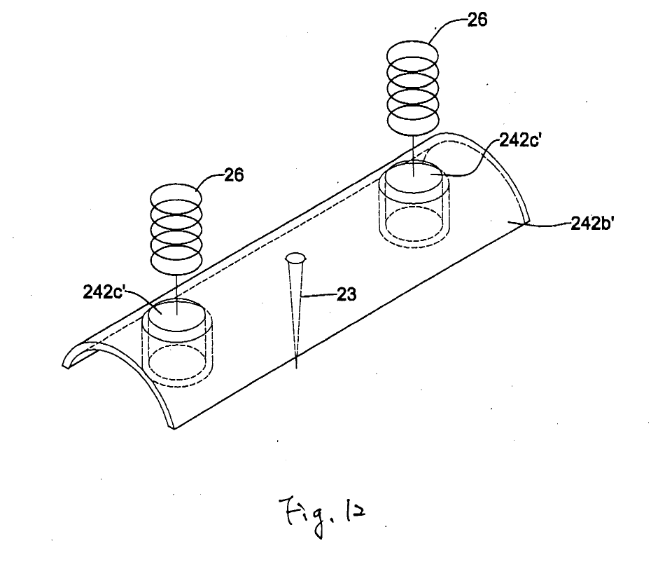

Referring to FIGS. 11, 11A and 12, a semicolumn type electric gas valve device is designed based on the electric gas valve device shown in FIG. 9. A magnetic actuating member 242b′ is designed with an arcuate section. A gastight member 23 is disposed at the bottom of the magnetic actuating member 242b′. Two recesses 242c′ are defined in the magnetic actuating member 242b′ and each receive a spring 26 therein. A ventilative hole 211 is defined corresponding to the gastight member 23. The electric gas valve device is disposed in a tube body 10. A sleeve 261 is defined in the tube body 10 corresponding to each recess 242c′ of the magnetic actuating member 242b′, thereby stably guiding movement of the outer sidewall of the recess 242c′. The spring 26 has an end abutting against the inner sidewall of the tube body 10. A gas supplementing volume space 31 is defined in the tube body 10. Therefore, the semicolumn type electric gas valve device achieves the object of gas supplementing to the chamber body 30 of the luminous tube as mentioned above. In this embodiment, a ventilative body and an electric gas valve device may be employed cooperatively.

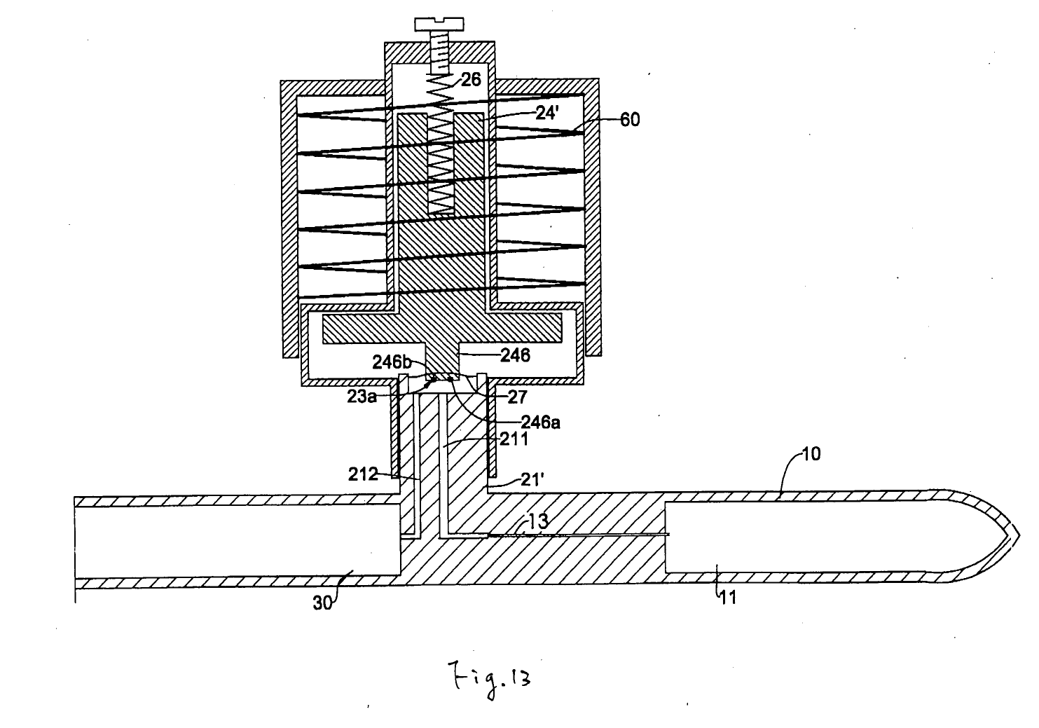

Referring to FIG. 13, a film type electric gas valve device includes a cross-shaped hollow pipe. A winding 60 is disposed outside the hollow pipe. A longitudinal actuating block 24′ is disposed in the hollow pipe. A pushing rod 246 is disposed at the bottom of the hollow pipe. A spring 26 is disposed between the actuating block 24′ and the inner wall of the cross-shaped hollow pipe. A stopper body 21′ is disposed at the tube body 10 connecting the cross-shaped hollow pipe and under the pushing rod 246. Two ventilative holes 211, 212 are defined in the stopper body 21′ and are respectively in communication with a gas supplementing bottle space 11 and a chamber body 30 of the luminous tube. The gas supplementing bottle space 11 and the chamber body 30 are disposed at opposite sides of the stopper body 21′. A receiving opening is defined in the stopper body 21′ corresponding to an end surface of the pushing rod 246. A sealing film 27 is disposed between the inner surface of the receiving opening and the pushing rod 246. An annular gasket is disposed between the sealing film 27 and the ventilative hole 211 of the stopper body 21′ thereby defining a gastight member 23a.

In an ordinary status, the spring 26 extends to push the pushing rod 246 of the actuating block 24′ to abut against the sealing film 27 whereby the gastight member 23a closes the ventilative hole 211 for being at a close status. When a sensor disposed at the chamber body 30 of the luminous tube detects gas in the chamber body 30 is insufficient, the sensor commands the electric gas valve device 20 to operate. That's, the actuating block 24′ moves to compress the spring 26 for upwardly moving the pushing rod 246 abutting against the sealing film 27 whereby a gas occurs between the gastight member 23a and the ventilative hole 211. Therefore, the gas in the gas supplementing volume space 31 flows through the ventilative hole 211 and into the ventilative hole 212 and the chamber body 30. Besides achieving to precisely and automatically supplement gas, the film type electric gas valve device is ready to manufacture and maintain. The vacuum chamber body of the luminous tube tends to be polluted and fails in work. Since the film type electric gas valve device only has the sealing film and the gasket in the vacuum chamber, it is easy to maintain during use of the luminous tube.

As an alternative embodiment of the gastight member 23a described above, a sealing film 27 is disposed at the pushing rod 246. An annular groove 246a is defined in the end surface of the pushing rod 246. A sealing ring 246b is received in the annular groove 246a. The sealing ring 246b closes or opens the ventilative hole 211 through movement of the pushing rod 246.

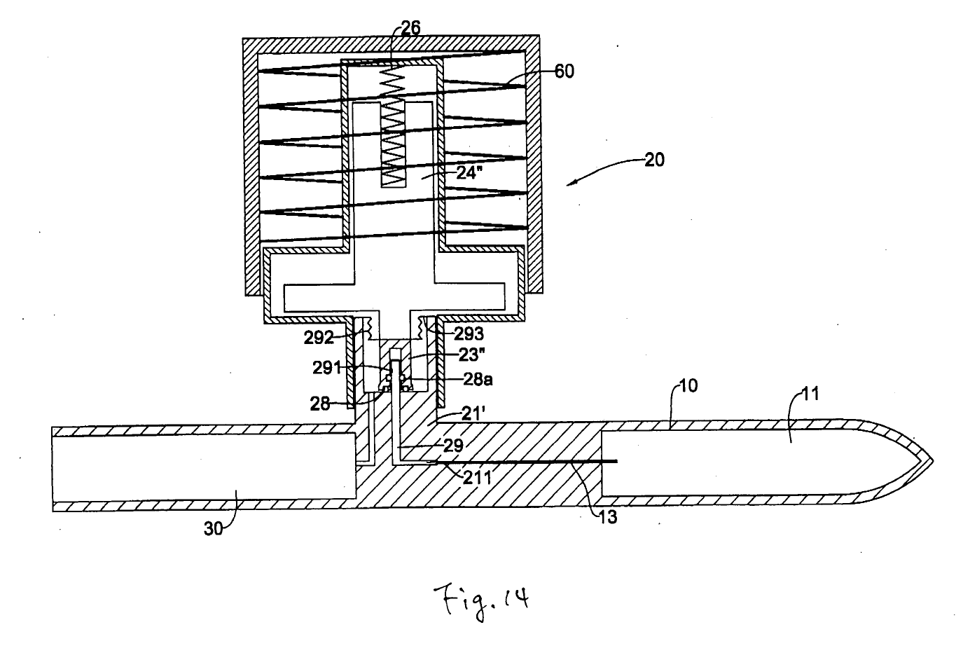

Referring to FIG. 14, a bellows type electric gas valve device is mostly similar to that shown in FIG. 13. The difference is described as follows. A pipe 29 with a side hole 291 being defined therein extends from a ventilative hole 211 of a stopper body 21′. A crapy film canister 292 is fixedly disposed at the actuating block 24″ for extending into the receiving opening at the top of the stopper body 21′. The crapy film canister 292 is open and has a skirt 293 engaging with the inner wall of the receiving opening of the stopper body 21′. A slot is defined in the bottom end surface of the crapy film canister 292 for receiving an end of the pipe 29, thereby defining a gastight member 23″. Annular gaskets 28, 28a are respectively disposed among the slot of the gastight member 23″, the pipe 29 and the stopper body 21′ for preventing from vibration for maintaining gastight. An actuating block 24′, a spring 26, a magnetic body 60 and a winding as shown in FIG. 13 are disposed at the gastight member 23″. Besides achieving the object of the present invention, the bellows type electric gas valve device can move up and down in a relatively long distance for preventing gas supplementing caused by vibration and so has better anti-vibration and gastight effects.

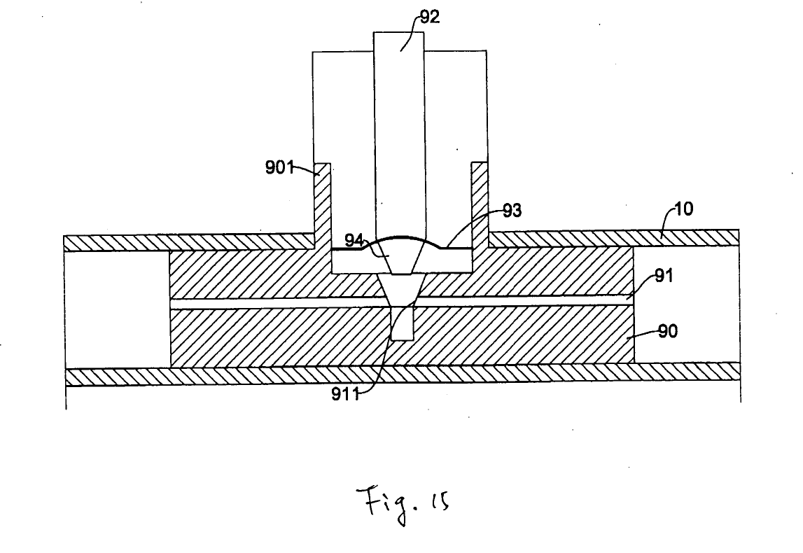

As shown in FIG. 15, a gastight member of a bellows type electric gas valve device is mostly similar to that shown in FIG. 13. The difference is described as follows. A tube body 10 is disposed with a T-shaped stopper body 90 therein. A protrusion 901 extends from a middle of the stopper body 90 and projects the tube body 10. A ventilative hole 91 is defined in the stopper body 90 along an axial direction thereof. A taper hole 911 is defined in the stopper body 90 in communication with the ventilative hole 91 along a diameter direction thereof. An actuating block 92 is disposed corresponding to the protrusion 901 with a taper end 94. A film 93 is disposed between the actuating block 92 and the stopper body 90. The film 93 is connected to the inner wall of a receiving opening defined by the protrusion 901. The taper end 94 is made of plastic and matches the taper hole 911 whereby when the taper end 94 extends into the taper hole 911, the ventilative hole 91 is closed or blocked, otherwise, the ventilative hole 91 is open.

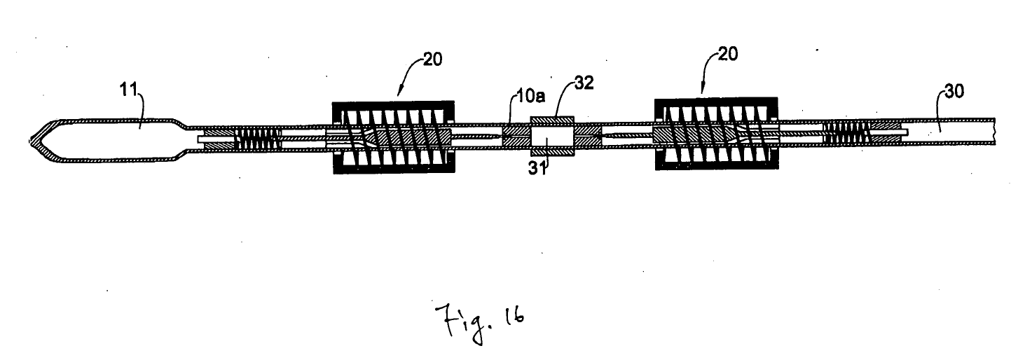

Referring to FIG. 16, a heater 32 is disposed outside the tube body 10a corresponding to the gas supplementing volume space 31 and the gas supplementing end. The inner pressure of the gas supplementing volume space 31 is increased through the heating of the heater 32 for increasing flow rate of the gas in the luminous tube thereby achieving instantaneous gas supplementing function. Thus, the luminous tube maintains a certain inner pressure for obtaining desired light thereby increasing use life thereof.

As described above, the present invention realizes gas supplementing of a discharge luminous tube through a gas valve device cooperating with a sensor thereby achieving the objects of precise and automatic gas supplementing. Furthermore, the heater makes full use of the remnant low pressure gas in the gas supplementing bottle space whereby the luminous tube maintains a certain inner pressure for obtaining desired light thereby increasing use life thereof. Any disposed at a chamber body of a luminous tube and employing a gas valve device to control gas supplementing falls within the scope of the present invention.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An automatic gas supplementing device for a discharge luminous tube comprising a hollow tube body with a gas supplementing bottle space being defined in an end thereof, the other end of the tube body connecting a chamber body of the luminous tube, a gas resistance component and an electric gas valve device being disposed in the tube body with a gas supplementing volume space being defined therebetween.

2. An automatic gas supplementing device for a discharge luminous tube comprising a hollow tube body with an end connecting a gas supplementing bottle space and the other end connecting a chamber body of the luminous tube, at least two electric gas valve devices being respectively disposed in the tube body with a gas supplementing volume space being defined therebetween.

3. The automatic gas supplementing device as claimed in claim 1 or 2, wherein each electric gas valve device is disposed in the tube body and includes two opposing stopper bodies disposed in the tube body, a ventilative hole and an elongate hole are respectively defined in the stopper bodies;
a gastight member is disposed corresponding to the ventilative hole, an actuating block is disposed at one side of the gastight member, a gap is defined between the actuating block and the tube body, a magnet is disposed in the actuating block, a winding is disposed outside the tube body corresponding to the magnet, a spring is disposed between the actuating block and the stopper body defined with the ventilative hole.

4. The automatic gas supplementing device as claimed in claim 3, wherein a sleeve is disposed corresponding to the ventilative hole of the stopper body, a through hole is defined in the sleeve, the gastight member is disposed in the sleeve, a tension spring is disposed between the sleeve and the actuating block, opposite ends of the spring are respectively fixed to the sleeve and the actuating block whereby the gastight member and the ventilative hole keep sealing contact.

5. The automatic gas supplementing device as claimed in claim 1 or 2, wherein each electric gas valve device is disposed in the tube body and includes two stopper bodies disposed in opposing sides thereof, a ventilative hole and an elongate hole are respectively defined in the stopper bodies, a magnetic actuating member is disposed between the two stopper bodies, the magnetic actuating member includes a guiding block disposed in the electric gas valve device and a magnetic body fixed to the tube body, a gap is defined between the guiding block and the magnetic body, the guiding block has one end disposed with a gastight member corresponding to the ventilative hole of the stopper body and the other end extending through magnetic body, a spring is disposed between the other end of the guiding block and the stopper body having the elongate hole, a gap is defined between a portion of the guiding block projecting the magnetic body and the magnetic body, a winding is disposed outside the tube body corresponding to the magnetic actuating member.

6. The automatic gas supplementing device as claimed in claim 5, wherein more than one connecting rod guiding blocks connect in series between the magnetic actuating members of the electric gas valve device disposed between the two stopper bodies in the tube body.

7. The automatic gas supplementing device as claimed in claim 6, wherein a sleeve is disposed corresponding to the ventilative hole of the stopper body, a through hole is defined in the sleeve, the gastight member is disposed in the sleeve, a tension spring is disposed between the sleeve and the actuating block, opposite ends of the spring are respectively fixed to the sleeve and the actuating block whereby the gastight member and the ventilative hole keep sealing contact.

8. The automatic gas supplementing device as claimed in claim 6, wherein a first pipe is disposed at the stopper body in the tube body, an end of the first pipe gastightly connects a second pipe, a sleeve is disposed outside the second pipe, an end of the guiding block is disposed with a gastight member corresponding to an opening of the second pipe, the guiding block is movable within the sleeve, two clipping rings are respectively defined at the guiding block and the sleeve, a spring is disposed between the two clipping rings whereby the gastight member closes the opening of the second pipe.

9. The automatic gas supplementing device as claimed in claim 8, wherein at least two magnetic actuating members controllable the gastight member are connected in series, each magnetic actuating member includes a movable guiding block, a magnetic body disposed in the tube body and a winding disposed outside the tube body, the guiding block of each magnetic actuating member is defined with a receiving space therein, a hole in an axial end thereof and a post in the other end thereof, a through hole is axially defined in the magnetic body, the post of the guiding block extends through the through hole of another magnetic actuating member and into the receiving space and then is formed with a big diameter at the free end thereof, a spring is disposed between the free end of the post and the inner wall of the receiving space.

10. The automatic gas supplementing device as claimed in claim 6, wherein a first pipe is disposed through the stopper body in the tube body, an end of the first pipe gastightly connects a second pipe, a sleeve is disposed outside the second pipe, an end of the guiding block is disposed with a gastight member corresponding to an opening of the second pipe and movable within the sleeve, an end of the sleeve is fixed to the post of the gastight member, a clipping ring is defined in the tube body, a spring is disposed between the clipping ring and the free end of the sleeve and outside the sleeve whereby the gastight member closes the opening of the first pipe through pushing the sleeve.

11. The automatic gas supplementing device as claimed in claim 1 or 2, wherein each electric gas valve device is disposed in the tube body and includes two stopper bodies disposed in opposite sides thereof, a ventilative hole and an elongate hole are respectively defined in the stopper bodies;
a gastight member is disposed corresponding to the ventilative hole, an actuating block is disposed at one side of the gastight member, the actuating block is hollow with a spring being defined therein, one end of the spring abuts against the stopper body defined with the elongate hole, the gastight member is disposed within the ventilative hole of the stopper body, a hollow pipe is disposed in a tube body between the two stopper bodies, a control plate is disposed in the hollow pipe, a fulcrum is disposed at the control plate and is pivoted about the hollow pipe, one end of the control plate is fixedly connected to the actuating block, a magnetic body is disposed outside the hollow pipe corresponding to the other end of the control plate, a winding is disposed outside the magnetic body.

12. The automatic gas supplementing device as claimed in claim 11, wherein the hollow pipe is L-shaped, a control plate is disposed in the vertical portion of the hollow pipe, one end of the control plate is fixedly connected to the actuating block and the other end of the control plate connects with a rod disposed at the horizontal portion of the hollow pipe, a magnetic body is disposed at one side of the rod, a winding is disposed outside the magnetic body.

13. The automatic gas supplementing device as claimed in claim 1 or 2, wherein each electric gas valve device is disposed in the tube body and includes two stopper bodies disposed in opposing sides thereof, a ventilative hole and an elongate hole are respectively defined in the stopper bodies;
a gastight member is disposed corresponding to the ventilative hole, an actuating block is disposed at one side of the gastight member, an end of the actuating block is hollow and receives a spring therein, the spring has one end disposed at the stopper body defined with the elongate hole, a gastight member is disposed at the other end of the actuating block and is received in the ventilative hole of the stopper body, a hollow pipe is disposed in communication with a chamber body of the luminous tube, a control plates is disposed in the hollow pipe and has an end fixedly connecting the actuating block, a magnetic body is disposed outside the hollow pipe corresponding to the control plates, a winding is disposed outside the magnetic body.

14. The automatic gas supplementing device as claimed in claim 1 or 2, wherein the electric gas valve device includes a cross-shaped hollow pipe, a winding is disposed outside the hollow pipe, an actuating block is disposed in the hollow pipe, a spring is disposed between the actuating block and the inner wall of the cross-shaped hollow pipe, a gastight member is disposed at the bottom of the actuating block, a stopper body defined with two ventilative holes therein is disposed at the bottom of the gastight member, a sealing film is disposed at the stopper body in a spaced distance, the two ventilative each have one end facing the sealing film and the other end respectively in communication with a gas supplementing volume space and a chamber body of the luminous tube.

15. The automatic gas supplementing device as claimed in claim 14, wherein a pushing rod is disposed at an end of the actuating block is defined with an annular groove corresponding to the ventilative hole, a sealing ring is received in the annular groove and at the outer edge of the ventilative hole.

16. The automatic gas supplementing device as claimed in claim 14, wherein the tube body is disposed with a T-shaped stopper body therein, a protrusion extends from a middle of the stopper body and projects the tube body, a ventilative hole is defined in the stopper body along an axial direction thereof, a taper hole is defined in the stopper body in communication with the ventilative hole along a diameter direction thereof, an actuating block is disposed corresponding to the protrusion with a taper end, a film is disposed between the actuating block and the stopper body, the film is connected to the inner wall of a receiving opening defined by the protrusion, the taper end matches the taper hole thereby closing or opening the ventilative hole.

17. The automatic gas supplementing device as claimed in claim 1 or 2, wherein the electric gas valve device includes a hollow pipe, a winding is defined outside the hollow pipe, an actuating block is disposed in the hollow pipe, a spring is disposed between the actuating block and the inner wall of the hollow pipe, a gastight member is disposed at he bottom of the actuating block, a stopper body with a ventilative hole defined therein is disposed at the bottom of the gastight member, a pipe with a side hole defined therein extends from the stopper body, a crapy film canister is fixedly disposed at the stopper body, a bellows is defined between crapy film canister and the stopper body, a slot is defined in the bottom of gastight member for receiving the pipe.

18. The automatic gas supplementing device as claimed in claim 2, wherein the electric gas valve device includes a magnetic actuating member designed with an arcuate section, a gastight member is disposed at the bottom of the magnetic actuating member, the magnetic actuating member is corresponding to a magnetic body and a winding both disposed outside the magnetic actuating member, two recesses are defined in the magnetic actuating member and each receive a spring therein, a ventilative hole is defined corresponding to the gastight member, the electric gas valve device is disposed in a tube body, a gas supplementing volume space is defined in the tube body for supplementing gas to a chamber body of the luminous tube.

19. The automatic gas supplementing device as claimed in claim 18, wherein a sleeve is defined in the tube body corresponding to each recess of the magnetic actuating member, one end of the sleeve is fixed to the tube body ad the other end is guidable movement of the outer sidewall of the recess.

20. The automatic gas supplementing device as claimed in claim 18 or 19, wherein opposite ends of the gas supplementing volume space in the hollow tube body are respectively connected with an electric gas supplementing device and a gas resistance component.

21. An automatic gas supplementing device for a discharge luminous tube comprising two electric gas valve devices respectively disposed in separated box bodies, a ventilative hole being defined between the two box bodies, two magnetic bodies and two windings controlling the two electric gas valve devices, each electric gas valve device being disposed with a plurality of hollow posts in the box body corresponding to the magnetic bodies and magnetic actuating members corresponding to the magnetic bodies, a recess being defined in the center of the magnetic actuating member, a spring being received in the recess, a gastight member being disposed under the magnetic actuating member corresponding to a ventilative hole, a plurality of post bodies being disposed under the magnetic actuating member corresponding to the hollow post, the opposite ends of the two box bodies respectively connecting a gas supplementing bottle space and a chamber body of the luminous tube.

22. The automatic gas supplementing device as claimed in claim 21, wherein the electric gas valve device and the chamber body of the luminous tube are separate with a conduit being connected therebetween.

23. The automatic gas supplementing device as claimed in claim 21 or 22, wherein opposite ends of the gas supplementing volume space in the hollow tube body are respectively connected with the electric gas supplementing device and a gas resistance component.

24. The automatic gas supplementing device as claimed in claim 21 or 22, wherein positions of the gas resistance component and the electric gas valve device are interchangeable.

25. The automatic gas supplementing device as claimed in claim 21 or 22, wherein a heater is disposed outside the tube body corresponding to the gas supplementing volume space and the gas supplementing end.

26. The automatic gas supplementing device as claimed in claim 21 or 22, wherein a sensor is disposed in the chamber body of the luminous tube.

27. The automatic gas supplementing device as claimed in claim 21 or 22, wherein a filter is disposed between the stopper body and the chamber body of the luminous tube for filtering impurity of the gas.

28. The automatic gas supplementing device as claimed in claim 21, wherein the gas resistance is replaced with a hollow pipe with a small diameter or a ventilative body, one end of the hollow pipe directly connects the ventilative hole of the gastight member.
